(19) United States
(12) Patent Application Publication
(10) Pub. No.: US 2010/0165495 A1
(43) Pub. Date: Jul. 1, 2010

(54) Collection optic for solar concentrating wedge

(76) Inventor: R. Michael Murtha, Oxnard, CA (US)

Correspondence Address: R. Michael Murtha, 1010 Janetwood Dr., Oxnard, CA, 93030, US

(21) Appl. No.: 12/319,072

(22) Filed: Dec. 29, 2008

(51) Int. Cl. G02B 5/08

(52) U.S. Cl. 359/853

(57) ABSTRACT

A nontracking solar concentrator, called the wedge, is given the ability to collect overhead light. This is made possible by a new prism, having the cross section of a cornucopia, that delivers an abundance of bright light into the wedge to create a higher intensity focus.

### BACKGROUND OF THE INVENTION

This invention relates to the collection of sunlight, specifically to a new panel that delivers overhead light into a solar concentrating wedge.

The two most practical nontracking solar thermal concentrators are the well known compound parabolic concentrator (CPC) and the lesser known optical wedge. Both collectors use a reflective geometry, instead of sun-tracking machinery, to focus light onto a heat pipe.

The low profile wedge is scalable. When filled with inexpensive water, the wedge can be built with a very large collection area and take advantage of the economies of scale that are necessary to become cost effective. The water-filled wedge can also transport any absorbed energy by flowing to the focus. In the past, however, each potential advantage was cancelled by the fact that a low profile wedge could only collect light from low in the sky.

### SUMMARY OF THE INVENTION

The primary object of this invention is to allow the wedge to collect overhead sunlight.

Accordingly, the primary object is accomplished in the following manner: a wedge-shaped tank is filled with water and a panel is placed on top. Inside the panel is a new prismatic guiding plate that takes powerful overhead light and folds it into angled beams that are acceptable to the wedge. The result is a scalable nontracking solar concentrator with a very hot focus.

Another object is to greatly reduce the cosine losses associated with the low profile wedge. Other objects and advantages will become apparent from the following detailed description and accompanying drawings.

### BRIEF DESCRIPTION OF THE DRAWINGS

FIG. 1 is an end view of a prior art water-filled wedge.

FIG. 2 is an end view of a water-filled wedge with new panel.

FIG. 3 is a partial view of the optics in the new panel.

FIG. 4 is an exploded view of the new panel.

FIG. 5 is a perspective view of a water-filled wedge with panels.

FIG. 6 is a partial view of the panel optics collecting solstice rays.

FIG. 7 is a partial view of the panel optics collecting equinox rays.

FIG. 8 is an end view of a water-filled wedge, panel and stacked-pipe absorber.

FIG. 9 is an end view of a water-filled wedge, panel and CPC secondary.

FIG. 10 is an end view of a 8° water-filled wedge and panel.

### DESCRIPTION OF THE INVENTION

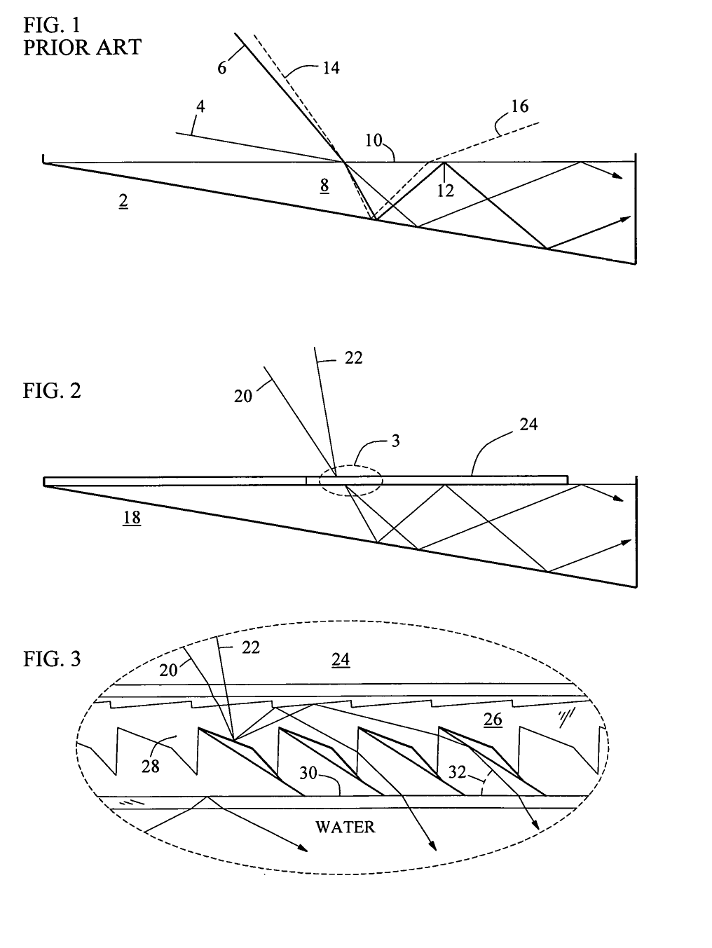

In FIG. 1, a prior art water-filled wedge 2 is shown collecting sunlight. Rays 4 and 6 outline the angular field of view of the nontracking solar concentrator. Ray 6 is the maximum elevation ray that the wedge can collect. After entering water 8 and reflecting from the bottom, ray 6 approaches water surface 10 at greater than the critical angle and is totally internally reflected 12 back into the water toward the focus. Whereas, if high ray 14 enters the water, it will reflect and exit the water as lost energy 16. Only the light between rays 4 and 6 can be collected.

A major problem for the prior art wedge is that before arriving at the collector the low-angled light passes through an extra thick air mass which absorbs much of the radiant energy.

The horizontal wedge also suffers a cosine loss. The light approaches water surface 10 at an oblique angle, causing a further decrease in the energy density of the light. For example, 60° incident light has an energy density half of what it could be because the cosine of 60 is 0.50.

The prior art wedge is limited to collecting low intensity light from low in the sky.

In FIG. 2, new water-filled wedge 18 collects powerful overhead light between rays 20 and 22 during the brightest part of the year. At the same time, high overhead light greatly reduces the cosine loss. Both improvements are made possible by panel 24 of the present invention.

FIG. 3. Inside of panel 24, there is a guiding plate 26 that has many rows of cornucopia-shaped prisms 28. Overhead rays 20 and 22 enter the plate and emerge diagonally toward bottom glass 30. All rays approaching the glass within angle range 32 (45° through 90°) can be accepted by the water-filled wedge and reflected to the focus.

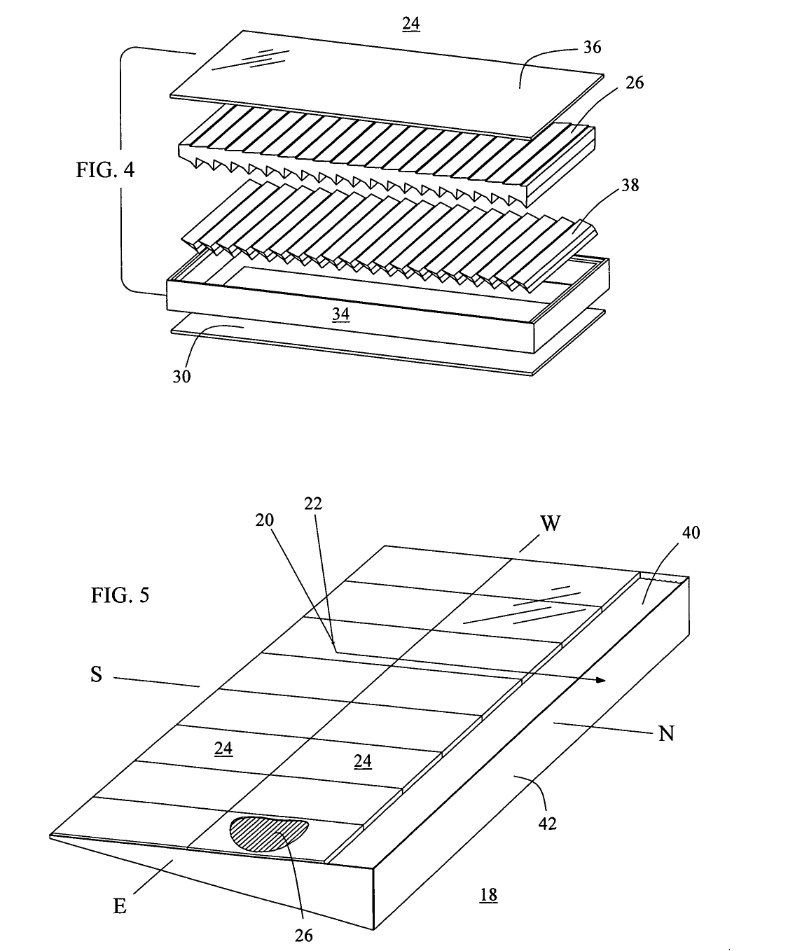

FIG. 4. Panel 24 is a watertight housing constructed of a frame 34, tempered low-iron bottom glass 30 and top glass 36. Plate 26 is manufactured in clear plastic by the injection molding process. Essential reflector 38 can be a polished aluminum strip or extrusion.

FIG. 5. Now that the wedge is capable of collecting high intensity light, it will make good economic sense to scale up. A larger collection area will make it necessary for panel 24 to be built in sections that are arrayed side by side. Each panel 24 is plane parallel to water surface 40 and may be placed on, above, or below the water surface. Plate 26 and the reflectors are oriented east to west.

Wedge 18 is shown in the northern hemisphere at the 34^{th} parallel (Los Angeles, Calif. for example) where light is collected from the southern sky and guided by total internal reflection to exit glass 42. High noon rays 20 and 22 define a 23.5° elevation field of view that allows solar collection three months before and three months after summer solstice. Azimuth field of view (not shown) changes over the six month collection period and is greatest around summer solstice.

The wedge's long axis is east to west, while overall length is determined by the temperature rise and flow rate requirements of a particular jobsite.

The work of the collector is to make fresh water and generate electricity without air pollution. The collector can make it's own demineralized water for use in the wedge tank.

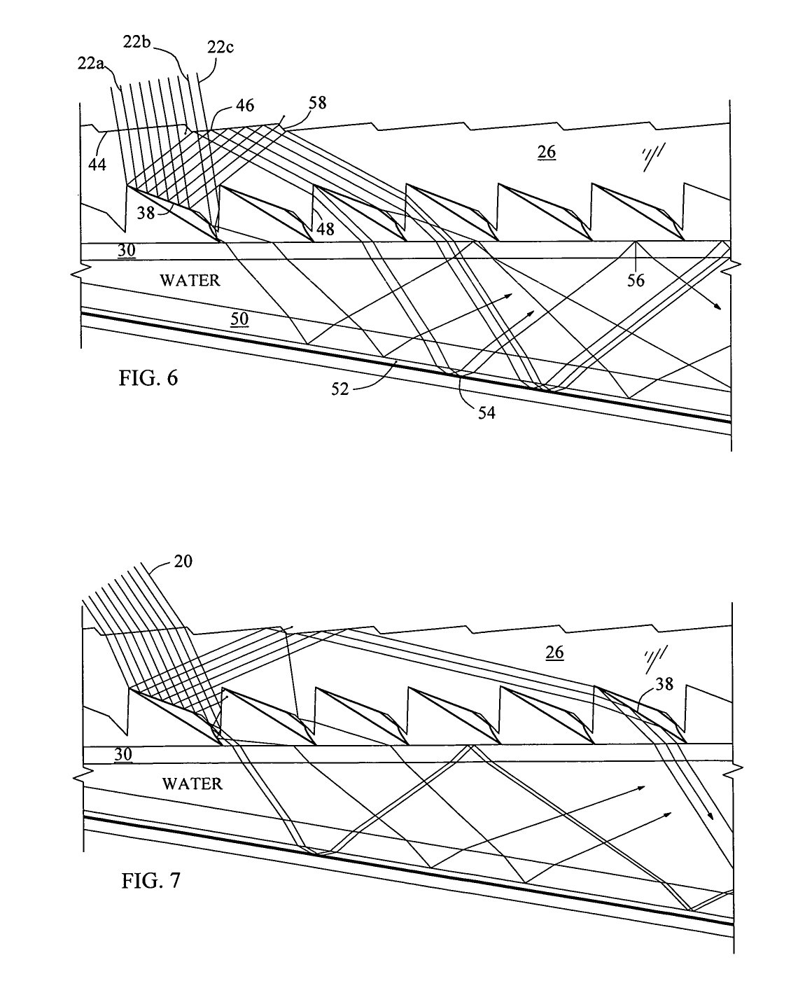

In FIG. 6, ten solstice rays are shown entering plate 26. Ray 22a impinges tilted first surface 44 and refracts into the clear plastic according to Snell's Law. Shaped reflector 38, adjacent to the second plastic surface, directs ray 22a up to point 46 where it internally reflects toward exit surface 48 and into the air, then traversing glass 30 and into the water. Ray 22a is the most steeply inclined of the rays, exiting wedge bottom glass 50 into air-gap 52 and reflecting at metallic mirror 54. All subsequent reflections at the wedge bottom are total internal reflections. Ray 22a approaches the glass/air interface at greater than the critical angle and is internally reflected 56 back into the water toward the focus downstream.

Ray 22b internally reflects from a different bottom facet of plate 26 and propagates into the water. Ray 22c internally reflects from an exit surface, refracts out the bottom facet to a “scoop” section of reflector 38 and into the water.

First surface facet 58 causes two of the rays to be lost, suggesting a plate 26 gross throughput of 80% for solstice rays.

In FIG. 7, equinox rays 20 enter, are guided and exit plate 26. The underside of reflector 38 directs some of the rays. Rays travel down through glass 30 and back up to glass 30 for a total internal reflection. If a anti-reflection film is deposited on the air side of glass 30, light transmission will be improved and total internal reflection will not be affected.

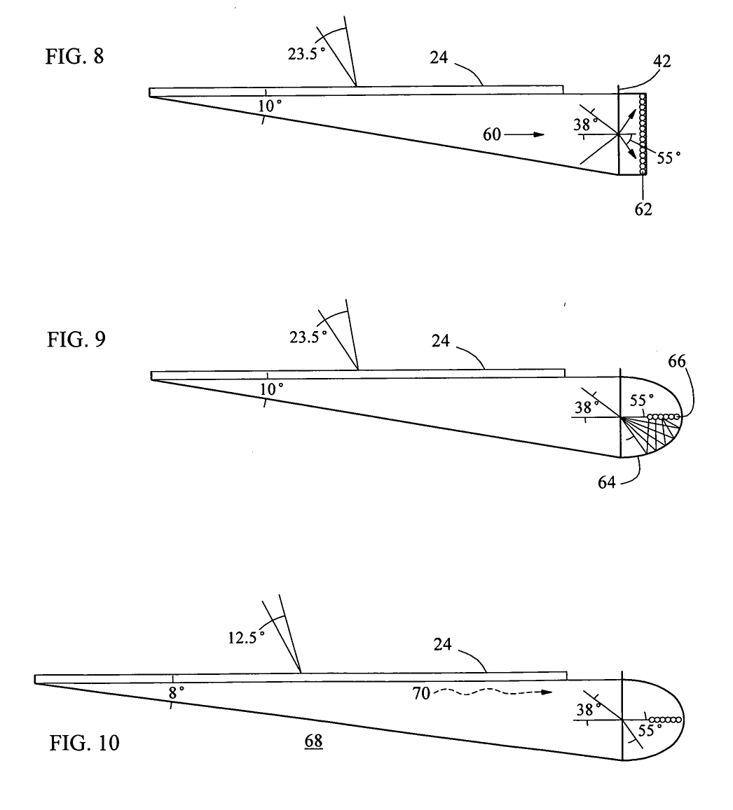

FIG. 8. Collected light 60 approaches exit glass 42 in a range of rays having a maximum half angle of 38°. The rays refract into air (55° half angle) and hit a stacked-pipe absorber 62, heating the working fluid inside. A geometric concentration ratio of 5:1 is found by dividing the panel 24 aperture by the maximum water height.

In FIG. 9, a CPC secondary reflector 64, designed to accept a 55° half angle, takes the 5× concentrated light and multiplies it 2.5 times resulting in a concentration ratio of 12.5:1. An additional benefit is that the concentrated light is distributed on both sides of absorber 66.

FIG. 10. Panel 24 allows the wedge to work at higher latitudes where the summer solstice sun appears lower in the sky. At the 40^{th} parallel for example, the lower solstice ray will be collected by 8° wedge 68. The smaller wedge angle produces a wider collector for a given height and a total geometric concentration ratio of 16:1. FIGS. 8, 9 and 10 have identical heights and all pipes are the same diameter. The trade-off is a smaller 12.5° field of view that equates to a collection period of 3.2 months (1.6 months before and after summer solstice).

Some of the collected light is absorbed by the water, raising the water temperature. This energy is not lost because warm water 70 flows under panel 24 toward the focus as preheated feed water for the pipes. Panel 24 insulates the warm water during the slow journey.

### SUMMARY

The reader has been shown a completely new optic that delivers the brightest light available into the water-filled solar concentrating wedge. The intense light will accelerate heat transfer operations in the collector for the first time.

There has always been a need for a cost effective solar concentrator. Now, the purely optical wedge has the power to be that technology.

I claim:

1. A light collecting optic, comprising:
1) a prismatic guiding plate
2) a plurality of reflectors
whereby said prismatic plate and said reflectors direct overhead light into a solar concentrating wedge.
